(19) United States
(12) Patent Application Publication
(10) Pub. No.: US 2004/0130748 A1
(43) Pub. Date: Jul. 8, 2004

(54) Data output apparatus and host apparatus

(75) Inventor: Hitoshi Hashimoto, Hyogo (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/732,316

(22) Filed: Dec. 11, 2003

(30) Foreign Application Priority Data
Dec. 16, 2002 (JP) 2002-363405

(51) Int. Cl. G06F 15/00

(52) U.S. Cl. 358/1.15

(57) ABSTRACT

A data output apparatus includes a data output request accepting section, an output data producing section, a page number counting section, and a code checking section. The data output request accepting section accepts data output request from the host apparatus. The data output request includes a data main body, new page orders, and serial number codes. The output data producing section subdivides the data main body in the page unit based on the new page orders to produce output data page by page. The page number counting section counts a page number of the output data produced. When the output data for a single page is produced by the output data producing section, the code checking section checks as to whether the serial number code corresponding to the produced output data is coincident with the page number counted by the page number counting section.

The present disclosure relates to the subject matter contained in Japanese Patent Application No. 2002-363405 filed on Dec. 16, 2003, which is incorporated herein by reference in its entirety.

### BACKGROUND OF THE INVENTION

1. Field of the Invention

The present invention relates to a data output apparatus such as a printer capable of printing in a unit of a page, and to a host apparatus such as a computer, which requests the printer to print.

2. Description of the Related Art

Known is a method for adding a new page code (new page order) to document data and transmitting the document data to a printer as print data in the configuration in which the document data is transmitted from an upper-level device such as a personal computer (will be referred to as a “PC” hereinafter) to a printer and the printer prints the transmitted document data is printed in a unit of a page.

In such a transmission method, since the document data containing the new page code is transmitted as the print data from the PC to the printer, and appearance conditions as to the new page code and a line break code in the document data received at this printer are monitored to detect a blank page, number of lines printed in a single page, number of blank lines at a page head, and number of blank lines contained in a single page. A condition of character strings printed is judged for every page based on this detected information. When printed characters conceived as abnormal continue over a plurality of pages, this method of the related art judges that an error occurs (JP-A-2001-175443).

By the way, a new page order may be changed to incorrect content due to communication noise produced while data is transmitted/received between a PC and a printer, or erroneous setting of communication interfaces. However, the printer of the related art does not include a function for checking as to whether or not a new page order itself is incorrect. Even when the technical idea described in JP-A-2001-175443, such an incorrect new page order must be processed actually, and also a printing error is judged merely after printing results have been obtained over a plurality of pages where the new page process had been carried out.

In other words, in the printer of the related art, while the data to be outputted is subdivided in the page unit based on the new page order issued from the PC, the data to be outputted is directly processed without checking the incorrect new page order. As a result, a large number of printing papers are outputted continuously, contents of which are different from contents to be printed out originally, for instance, a blank page and a character alteration.

### SUMMARY OF THE INVENTION

The present invention has been made under these circumstances. Therefore, an object of the invention is to provide a data output apparatus and a host apparatus, which can judge as to whether a new page order is normal or incorrect, and thus can firmly avoid continuous data-output errors to occur over a plurality of pages.

To achieve the above-explained object, the invention may employ the following measure.

According to a first aspect of the invention, a data output apparatus outputs data in a page unit in response to a data output request transmitted from a host apparatus. The data output apparatus includes a data output request accepting section, an output data producing section, a page number counting section, and a code checking section. The data output request accepting section accepts the data output request from the host apparatus. The data output request includes a data main body to be outputted, a plurality of new page orders used to subdivide the data main body in the page unit, and a plurality of serial number codes added to the new page orders, respectively. The output data producing section subdivides the data main body in the page unit based on the new page orders to produce output data page by page. The page number counting section counts a page number of the output data produced by the output data producing section. When the output data for a single page is produced by the output data producing section, the code checking section checks as to whether the serial number code corresponding to the produced output data is coincident with the page number counted by the page number counting section to confirm as to whether the serial number code is incorrect with respect to the counted page number.

As a preferred embodiment, the data output apparatus may further include a data output stopping section for stopping the output data producing section outputting the output data in the page unit when the code checking section detects that the serial number code is incorrect with respect to the counted page number.

As another preferred embodiment, the data output apparatus may further include an error notifying section for notifying the host apparatus of an error when the code checking section detects that the serial number code is incorrect with respect to the counted page number.

According to a second aspect of the invention, a host apparatus transmits a data output request to a data output apparatus for outputting data in a page unit. The host apparatus includes a data output request issuing section for issuing the data output request including a data main body to be outputted, a plurality of new page orders used to subdivide the data main body in the page unit, and a plurality of serial number codes added to the new page orders, respectively.

As a preferred embodiment, the host apparatus may further include an error notifying section. When the error notifying section receives an error notification issued based on the serial number codes from the data output apparatus after the data output request has been issued, the error notifying section notifies the error notification.

According to the embodiment of the invention, when a data output request including a data main body to be outputted, new page orders, and serial number codes is transmitted from a host apparatus, the following processes are performed in the data output apparatus such as a printer. The data main body to be outputted is subdivided page by page based on the new page orders, and then the subdivided data main bodies are sequentially output (printed out) in the page unit. Then, when the output data of each page is produced, a page number of this output data is counted (information for indicating output data of which page is counted). Furthermore, a confirmation is made as to whether or not this counted page number is incorrect (coincident or not) with respect to a serial number code added in correspondence with this output data. This serial number code corresponds to a page number within the data main body. In other words, when the output data is output, a check is made as to whether or not the counted page number is a correct page number.

As a consequence, in the data output apparatus, the new page order being not coincident with the serial number code among the new page orders contained in the received data output request can be judged as the incorrect information, which is produced by the communication noise. As a consequence, when an incorrect new page order is detected, for instance, the data output operation may be stopped at this detection time of the incorrect new page order, and/or the error notification may be issued to the host apparatus of the data output request source, so that an inconvenient event can be avoided. That is, in this inconvenient event, the output data, which have been subdivided in the page unit in the improper manner, are continuously output over multiple pages.

Other features and advantages of the invention may become apparent from a detailed description to be explained with reference to drawings.

### BRIEF DESCRIPTION OF THE DRAWINGS

FIG. 1 is a block diagram for showing an entire system containing an apparatus according to the invention.

FIG. 2 is an explanatory diagram for explaining a content of a print request.

FIG. 3 is an explanatory diagram for explaining a content of status information.

FIG. 4 shows a data flow chart for describing data flow operations when a printing operation is carried out.

### DETAILED DESCRIPTION OF THE PREFERRED EMBODIMENT

Referring to drawings, preferred embodiments of the invention will be explained specifically.

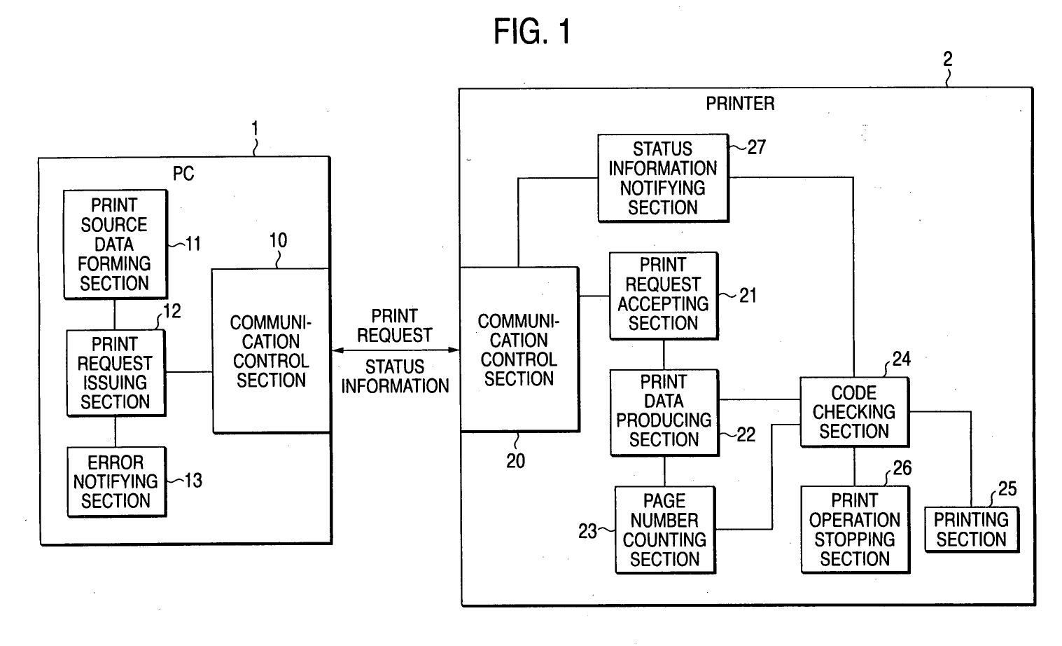

FIG. 1 is a block diagram showing an entire system containing an apparatus according to the embodiment of the invention. In the system, a PC 1 functioning as a host apparatus and a printer 2 functioning as a data output apparatus and being capable of printing in the unit of a page are connected. The PC 1 includes a communication control section 10, a print source data forming section 11, a print request issuing section 12, and an error notifying section 13. The printer 2 includes a communication control section 20, a print request accepting section 21, a print data producing section 22, a page number counting section 23, a code checking section 24, a printing section 25, a print operation stopping section 26, and a status information notifying section 27.

As to the PC 1, the communication control section 10 is implemented by a hardware corresponding to a communication interface such as a USB, a Centronics interface, a SCSI, or a LAN. The communication control section 10 exchanges various sorts of information with the communication control section 20 of the printer 2. The print source data forming section 11 is implemented by software such as a word processor, graphics software, and a spreadsheet software. This print source data forming section 11 transfers word processor data, graphics data, and spreadsheet data, which are produced by a user, as print source data to the print request issuing section 12. The print request issuing section 12 is implemented by software referred to as a “printer driver”. When the print source data is received from the print source data forming section 11, this print request issuing section 12 allocates this print source data in the unit of a page to form print request data (will be explained later), and then, transmits the print request data to the printer 2. The error notifying section 13 is one of functions of the printer driver. When the error notifying section 13 receives an error notification as status information transmitted from the printer 2, the error notifying section 13 displays an error message on a screen of a display unit of the PC 1.

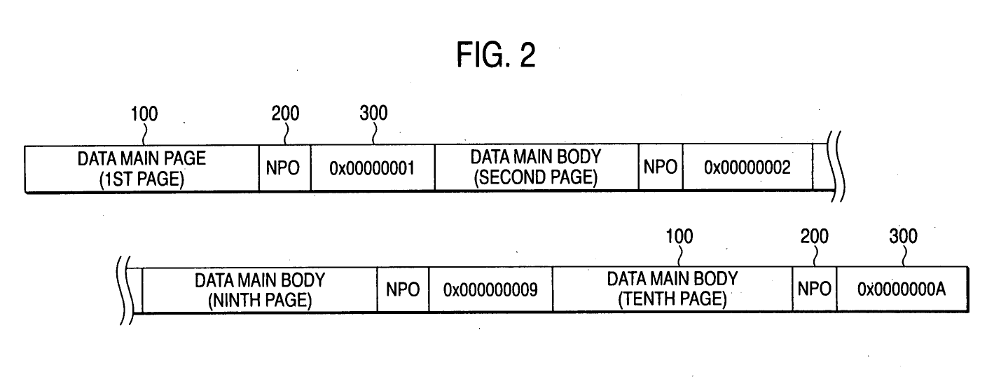

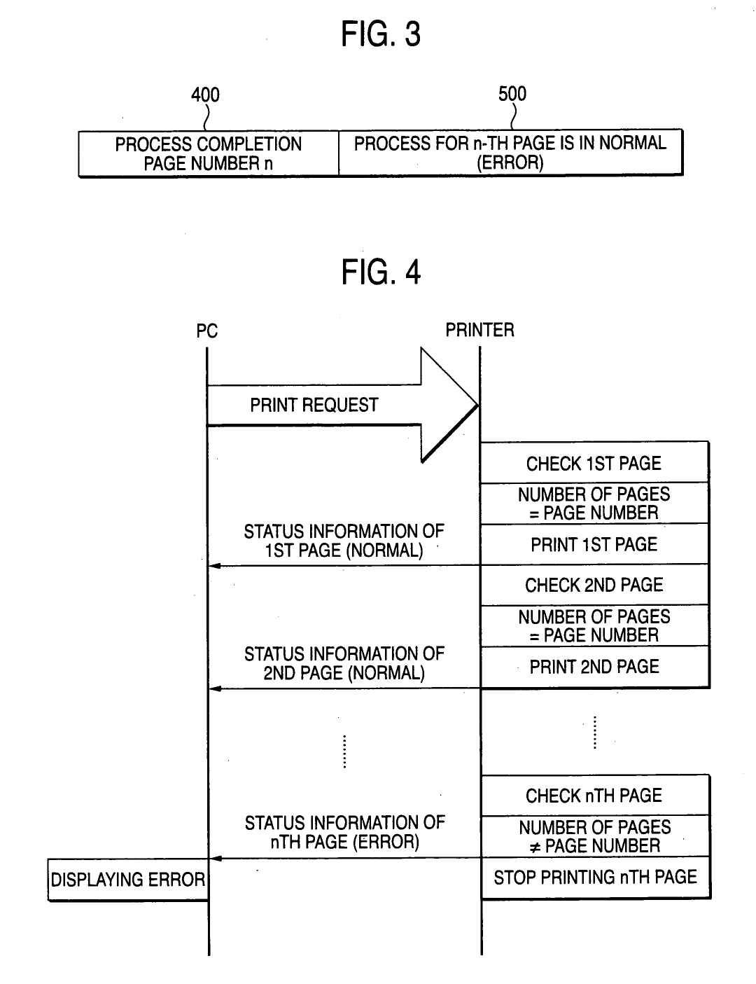

FIG. 2 is an explanatory diagram for explaining content of a print request, and FIG. 3 is an explanatory diagram for explaining content of status information. First, as shown in FIG. 2, the print request is a transmission frame used to transmit the print source data to the printer 2, and has data structure in which the print source data are continuously arranged in the unit of a page. The print request contains data main bodies 100, new page orders (will be abbreviated as “npo” hereinafter) 200, and page numbers 300. The data main bodies 100 should be printed as print source data in the unit of a page. The new page orders 200 are used to discriminate the data main bodies 100 from each other in the page unit. The page numbers 300 are allocated to every new page order 200 as serial codes. The data main bodies 100, the npo 200, and the page numbers 300 are grouped in the page unit, and constitute a continued structure in the order of pages from a first page to a final page. The print request issuing section 12 subdivides the print source data formed in a word processor form, a graphics form, or a spreadsheet form in the page unit, to obtain the data main bodies 100. Each of the data main bodies 100 includes print data containing print controlling codes for a single page. The npo 200 includes predetermined common code strings, and has data size of several bytes. The page numbers 300 has one-to-one correspondence relation with respect to the npo 200, and are sequentially allocated to the new page order 200 in a serial manner from 1. In FIG. 2, least significant bits of [0x00000001 ], [0x00000002], [0x00000009], and [0x0000000A] represent the page numbers, and correspond to a new page order of a first page, a new page order of a second page, a new page order of a ninth page, and a new page order of a tenth page, respectively. It should be noted that since the page numbers 300 is the hexadecimal number, the page number of the tenth page is “A”.

Also, the status information is transmitted from the printer 2 to the PC 1 every time the printer 2 accomplishes a data process for a single page, and indicates content of a result obtained in this data process. As shown in FIG. 3, the status information includes page number information 400 and information 500. The page number information 400 indicates a total number of pages for which the data process has been completed at a time when the status information is transmitted. The information 500 indicates as to whether the data process is performed under normal condition or error condition. When the content of the information 500 of the status information indicates an error of the data process, the error notifying section 13 displays an error message on the screen of the display unit of the PC 1.

Referring back to FIG. 1, the printer 2 is described again. The communication control section 20 is implemented by a hardware corresponding to a communication interface such as a USB, a Centronics interface, a SCSI, or a LAN. The communication control section 20 transmits/receives various sorts of information to/from the communication control section 10 of the PC1. The printing section 25 is a main unit for executing printing by way of, for example, an electrophotographic system, and performs the printing page by page based on print data containing a print controlling code. The print request accepting section 21, the print data producing section 22, the page number counting section 23, the code checking section 24, the print operation stopping section 26, and the status information notifying section 27 are implemented by a microcomputer functioning as a so-called “printer engine”.

The print request accepting section 21 accepts the print request data issued from the PC 1, and then transfers the data main bodies 100, the npo 200, and the page numbers 300, which are contained in this print request data, to the print data producing section 22 in the page order. Every time the npo 200 is detected, the print data producing section 22 extracts the data main body 100 for a single page, and then, produces print data containing the print controlling code from the extracted data main body 100. Also, the print data producing section 22 transmits the produced print data and the page number 300, which is detected together with the npo 200 to the code checking section 24. The page number counting section 23 counts up a total number of pages, which have been produced one by one every time the print data is produced. The total page number counted up in this manner is transmitted to the code checking section 24. The code checking section 24 compares the transmitted page number with the page number 300 every time the print data is produced. When the transmitted page number is coincident with the page number 300, the code checking section 24 judges that the page number 300 is normal and transmits the print data of this page to the printing section 25. Then, when the printing is accomplished under normal condition, the code checking section 24 notifies a message indicating that the printing process of this page is completed under normal condition to the status information notifying section 27. On the other hand, when the transmitted page number is not coincident with the page number 300, the code checking section 24 judges that the page number 300 is incorrect and regards the npo 200 corresponding to this incorrect page number 300 as an incorrect code stream. Then, the code checking section 24 informs this incorrect code stream to the print operation stopping section 26 and the status information notifying section 27. When the incorrect npo 200 is informed to the print operation stopping section 26, this print operation stopping section 26 causes the printing section 25 to stop (cease) printing of a page corresponding to this incorrect npo 200. When the incorrect npo 200 is notified to the status information notifying section 27, the status information notifying section 27 produces status information indicating a print error of the page corresponding to the incorrect npo 200, and then transmits the produced status information to the PC 1. It should be noted that upon receiving the message indicating that the printing process is accomplished under normal condition from the code checking section 24, the status information notifying section 27 produces a status information indicating that the printing process is accomplished under normal condition, and then transmits the produced status information to the PC1.

Next, printing operations will now be explained.

FIG. 4 shows a data flow chart for explaining data flow when a printing operation is executed. As shown in this drawing, when the printing operation is executed, a print request is firstly issued from the PC 1 the printer 2. This print request contains the data main bodies 100, the npo 200, and the page numbers 300, which are continuously transmitted in the page order.

The printer 2 sequentially receives the data main bodies 100, the npo 200, and the page numbers 300, which are temporarily stored in a buffer memory (not shown). Then, every time the npo 200 is read out from the buffer memory, the data main body 100 for a single page is converted into print data. Just before the printing operation for the single page is executed based on the converted print data, the code checking section 24 confirms as to whether or not the page number counted by the page number counting section 23 is coincident with content (namely, page number) of the page number 300 corresponding to this print data.

For example, as shown in FIG. 4, as a result of the identification between a page number of a first page and the page number 300, when the page number at this time (in this case, page number=1) is coincident with the page number 300, a printing operation is executed based on the print data of the first page.

Thereafter, when the printing process for the first page is accomplished under normal status, status information for the first page is transmitted from the printer 2 to the PC 1, and this status information indicates that the printing process for the first page is completed under normal condition. It should also be noted that when the PC 1 receives the status information indicating that the printing process for the first page is accomplished under normal condition, the PC 1 may delete the print source data for the first page. It should be understood that the print source data for all of the pages may be held until the printing operations for all pages are accomplished under normal condition.

For a second page and the subsequent pages, a series of the above-described processes are repeatedly executed in a similar manner to that of the first page to execute the printing process. It should also be understood that when an amount of data transmitted from the PC 1 to the printer 2 exceeds the storage capacity of the buffer memory, the printing operation is simultaneously executed, while a print request is received.

On the other hand, as shown in FIG. 4, as a result of the identification between a page number of an n-th page and the page number 300, there may occur a case in which a page number at this time (in this case, page number=n) is not coincident with the page number 300. This mismatch is caused by the following reason. That is, a print request is changed to an incorrect request content due to communication noise occurred when data is transmitted/received between the PC 1 and the printer 2, and also erroneous setting of either the printer driver or the communication protocol, so that the same code stream as the npo 200 is contained at a position, which is different from the correct position.

In such a case, printing operations as to pages subsequent to the n-th page is ceased without executing a printing operation based on the print data of the n-th page. As a consequence, a normal print result as to an (n−1)th page, which has already been printed out, can be obtained, and blank pages or pages having character alternation subsequent to the n-th page are not printed out. Also, status information indicating that a print error occurs at the n-th page is transmitted from the printer 2 to the PC 1. As a result, a message indicating that the print error occurs at the n-th page is displayed on the screen of the PC 1. The user who has confirmed this print error can again execute the necessary operation for a print request starting from the n-th page with respect to the printer 2.

As apparent from the foregoing description, the print error may occur in a first page. In particular, when a print request includes incorrect content from the beginning due to erroneous setting of either a printer driver or a communication protocol, a print error may be produced from a first page. Even in such a case, since a similar process to that of the above-explained n-th page case is performed, a printing operation as to the first page and the succeeding pages is stopped. Namely, the printing operation is not executed at all and in addition, status information indicating that the print error occurs at the first page is transmitted from the printer 2 to the PC 1. Subsequently, the user may change setting of the printer driver or setting of the communication protocol, and thereafter, the user may again perform the necessary operation for the print request starting from the first page with respect to the printer 2.

As a consequence, in accordance with the embodiment, when the page number 300 transmitted from the PC 1 together with the npo 200 is incorrect, the npo 200 corresponding to this page number 300 can be regarded as the incorrect npo. Therefore, it can be judged as to whether or not the npo 200 is incorrect using the page number 300. Then, when the incorrect npo 200 (namely, page number 300) is detected, the printing operation for the page at a time when this incorrect npo 200 is detected can be ceased. Also, the error notification can be issued with respect to the PC1. As a consequence, such a continuous printing error can be firmly avoided in which blank pages are produced and character alternations occur in a large number of pages.

Not only it is possible to avoid useless ejections of papers, but also the printer 2 can be operated in a higher efficiency without uselessly consuming consumable stores such as a toner.

Also, the user can confirm the print error occurring in the printer 2 using the PC 1, so that the convenience of the printer 2 can be improved without any direct confirmation of the print result.

It should be understood that the invention is not limited only to the above-described embodiment.

The data output apparatus may be a facsimile apparatus. In this alternative case, the host apparatus is another facsimile apparatus functioning as a transmission source.

When the print error occurs, the printing operation can be restarted from a page corresponding to the print error by the operation made by the user. Alternatively, for example, when a print error occurs in a half way while a certain page is printed under normal condition, the checking may be again executed as to number of pages and a page number at the page corresponding to this print error. If a normal print result is obtained, a printing operation may be automatically restarted from the relevant page. Alternatively, even when a print error occurs in a half way of a printing operation, the printing operation may be executed from a first page.

According to the embodiment of the invention, a data output apparatus outputs data in a page unit in response to a data output request transmitted from a host apparatus. The data output apparatus includes a data output request accepting section for accepting the data output request from the host apparatus, wherein the data output request includes a data main body to be outputted, a plurality of new page orders used to subdivide the data main body in the page unit, and a plurality of serial number codes added to the new page orders, respectively; an output data producing section for subdividing the data main body in the page unit based on the new page orders to produce output data page by page; a page number counting section for counting a page number of the output data produced by the output data producing section; and a code checking section for, when the output data for a single page is produced by the output data producing section, checking as to whether the serial number code corresponding to the produced output data is coincident with the page number counted by the page number counting section to confirm as to whether the serial number code is incorrect with respect to the counted page number.

According to the embodiment of the invention, the data output apparatus further includes a data output stopping section for stopping the output data producing section outputting the output data in the page unit when the code checking section detects that the serial number code is incorrect with respect to the counted page number.

According to the embodiment of the invention, the data output apparatus further includes an error notifying section for notifying the host apparatus of an error when the code checking section detects that the serial number code is incorrect with respect to the counted page number.

According to the embodiment of the invention, a host apparatus transmits a data output request to a data output apparatus for outputting data in a page unit. The host apparatus includes a data output request issuing section for issuing the data output request including a data main body to be outputted, a plurality of new page orders used to subdivide the data main body in the page unit, and a plurality of serial number codes added to the new page orders, respectively.

According to the embodiment of the invention, the host apparatus further includes an error notifying section. When the error notifying section receives an error notification issued based on the serial number codes from the data output apparatus after the data output request has been issued, the error notifying section notifies the error notification.

According to the embodiment of the invention, a computer program causes a computer to issue a data output request to a data output apparatus for outputting data in a page unit. The computer program causes a computer to issue a data main body to be outputted, a plurality of new page order used to subdivide the data main body in the page unit, and a plurality of serial number codes added to the respective new page order as the data output request to the data output apparatus.

As described above, in accordance with the embodiment of the invention, the new page order, which is not coincident with the serial number code, among the new page order contained in the received data output request can be judged as the incorrect information produced by the communication noise. As a consequence, when the incorrect new page order is detected, for instance, the data output operation may be stopped at this detection time of the incorrect new page order, and/or the error notification may be issued to the host apparatus of the data output request source, so that an inconvenient event can be avoided. That is, in this inconvenient event, the output data which have been subdivided in the page unit in the improper manner are continuously outputted over multiple pages.

What is claimed is:

1. A data output apparatus for outputting data in a page unit in response to a data output request transmitted from a host apparatus, the data output apparatus comprising:
a data output request accepting section for accepting the data output request from the host apparatus, wherein the data output request includes a data main body to be outputted, a plurality of new page orders used to subdivide the data main body in the page unit, and a plurality of serial number codes added to the new page orders, respectively;
an output data producing section for subdividing the data main body in the page unit based on the new page orders to produce output data page by page;
a page number counting section for counting a page number of the output data produced by the output data producing section; and
a code checking section for, when the output data for a single page is produced by the output data producing section, checking as to whether the serial number code corresponding to the produced output data is coincident with the page number counted by the page number counting section to confirm as to whether the serial number code is incorrect with respect to the counted page number.

2. The data output apparatus according to claim 1, further comprising:
a data output stopping section for stopping the output data producing section outputting the output data in the page unit when the code checking section detects that the serial number code is incorrect with respect to the counted page number.

3. The data output apparatus according to claim 1, further comprising:
an error notifying section for notifying the host apparatus of an error when the code checking section detects that the serial number code is incorrect with respect to the counted page number.

4. A host apparatus for transmitting a data output request to a data output apparatus for outputting data in a page unit, the host apparatus comprising:
a data output request issuing section for issuing the data output request including a data main body to be outputted, a plurality of new page orders used to subdivide the data main body in the page unit, and a plurality of serial number codes added to the new page orders, respectively.

5. The host apparatus according to claim 4, further comprising:
an error notifying section, wherein when the error notifying section receives an error notification issued based on the serial number codes from the data output apparatus after the data output request has been issued, the error notifying section notifies the error notification.
